(19) United States
(12) Patent Application Publication
(10) Pub. No.: US 2011/0168497 A1
(43) Pub. Date: Jul. 14, 2011

(54) ELEVATOR DOOR SYSTEM

(75) Inventors: JongChan Mun, Seoul (KR); Ju-Dae Kim, Seoul (KR); JongGil Byun, Seoul (KR)

(73) Assignee: OTIS ELEVATOR COMPANY, Farmington, CT (US)

(21) Appl. No.: 13/063,352

(22) PCT Filed: Dec. 19, 2008
(86) PCT No.: PCT/US2008/013895

§ 371 Date: Mar. 10, 2011

(30) Foreign Application Priority Data
Sep. 19, 2008 (KR) 10-2008-0092265

(51) Int. Cl. B66B 13/08; B66B 13/06

(52) U.S. Cl. 187/334; 16/96 R; 16/93 R

(57) ABSTRACT

An elevator door system includes an elevator door (12) having a first door panel (14a), a second door panel (14b), and a doorsill (24). A first door support frame (28a) is attached at a lower portion of the first door panel (14a). The first door support frame (28a) has a first finger (36a) that extends below the second door panel (14b) when the elevator door (12) is closed. A second door support frame (28b) is attached at a lower portion of the second door panel (14b). The second door support frame (28b) has a second finger (36b) that extends below the first door panel (14a) when the elevator door (12) is closed.

### CROSS-REFERENCE TO RELATED APPLICATIONS

This application is an international PCT patent application that claims priority to Korean Patent Application No. 10-2008-0092265, which was filed on Sep. 19, 2008 and which is incorporated herein by reference in its entirety.

### BACKGROUND

The present invention relates to inhibiting breakaway of an elevator door, typically caused when an abnormal force is applied to the door by a passenger.

Center-opening elevator doors commonly have two door panels that move in opposite horizontal directions by means of hanger rollers installed along a guide rail at the upper portion of each door panel. At the lower portion of each door, multiple devices are installed on each door panel. One device has a connecting segment and a guide shoe attached to the connecting segment. The guide shoe has a thickness that corresponds with a groove in the doorsill. Another device, a door injury deterrent apparatus, is fixedly installed in the middle of the doorsill to inhibit breakaway of the door when the door is closed. Hook rings are installed so that they are hooked and fastened to the door injury deterrent apparatus.

This prior art door injury deterrent apparatus presents problems in that foreign debris may fall into the groove in the doorsill, which can inhibit the door from properly opening and closing. The amount of debris accumulated in the doorsill cannot be visually determined, so the timing of cleaning is unpredictable.

In light of the foregoing, the present invention aims to resolve one or more of the aforementioned issues that can affect elevator doors systems.

### SUMMARY

An embodiment of the present invention relates to an elevator door system. The elevator door system includes an elevator door having a first door panel, a second door panel, and a doorsill. A first door support frame is attached at a lower portion of the first door panel. The first door support frame has a first finger that extends below the second door panel when the elevator door is closed. A second door support frame is attached at a lower portion of the second door panel. The second door support frame has a second finger that extends below the first door panel when the elevator door is closed.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are hereafter briefly described.

FIG. 1 is an elevation view of an embodiment of an elevator system according to the present invention, including a door guide apparatus.

FIG. 2 is a detailed view of the door guide apparatus as installed in the elevator system shown in FIG. 1.

FIG. 3 is an exploded view of a single door support frame of the door guide apparatus shown in FIG. 2.

FIG. 4 is a bottom view of the door guide apparatus as installed and shown in FIG. 2.

FIGS. 5A-5B are views showing the door guide apparatus when a force is applied to a door on which the door guide apparatus is installed.

### DETAILED DESCRIPTION

Efforts have been made throughout the drawings to use the same or similar reference numerals for the same or like components.

The present invention is a door guide apparatus for inhibiting the breakaway of an elevator door that not only guides a door so that it is precisely opened and closed along a groove of a doorsill, but also prevents, or at least substantially inhibits, the separation of the door due to an abnormal force applied to the door while the door is closed.

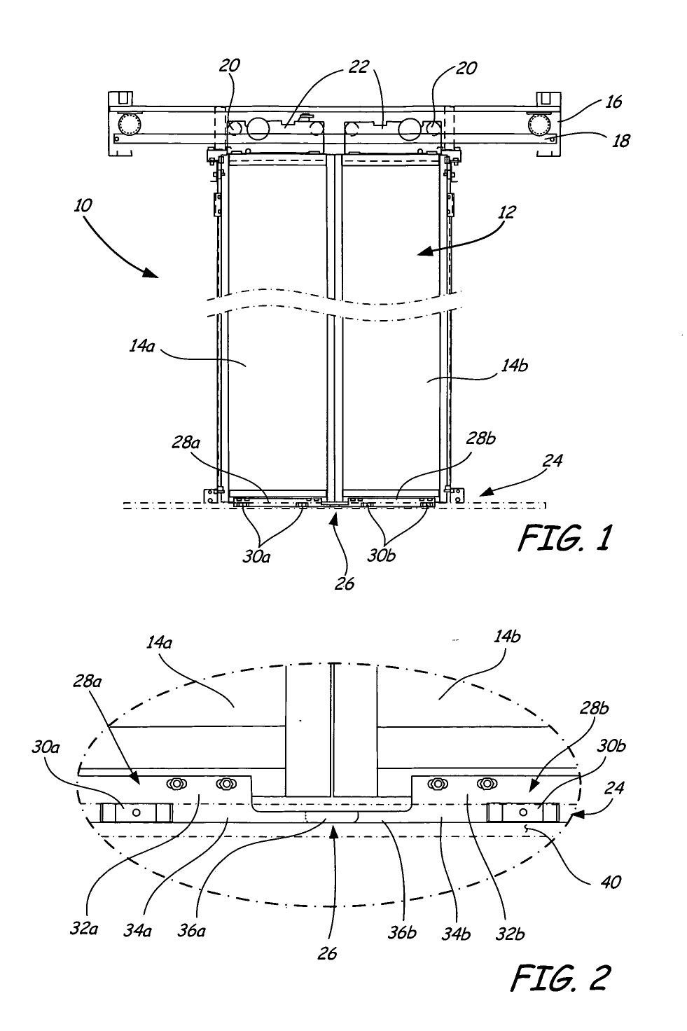

FIG. 1 is an elevation view of elevator door system 10 according to the present invention. Elevator system 10 includes door 12 (having left door panel 14a, right door panel 14b, and doorsill 24), header 16, track 18, rollers 20, hangers 22, and door guide apparatus 26 (which includes left door support frame 28a, right door support frame 28b, left door shoes 30a, and right door shoes 30b). Header 16 is arranged above door panels 14a, 14b and includes track 18, which extends along the length of header 16. Track 18 receives rollers 20, which move along track 18. Hangers 22 are connected to rollers 20 and door panels 14a, 14b. As rollers 20 move along track 18, hangers 22 also move along track 18, and doors 14a, 14b move with hangers 22 in order to open and close door 12.

FIG. 2 is a detailed view of the door guide apparatus 26, which includes door support frames 28a and 28b and door shoes 30a and 30b. Door support frames 28a and 28b are made of a rigid material and fixedly attached to the lower portions of door panels 14a and 14b, respectively. Door shoes 30a and 30b are attached at the bottom of door support frames 28a and 28b, respectively. Door shoes 30a and 30b guide the movement of door panels 14a and 14b along groove 40 in doorsill 24 (groove 40 is shown in phantom in FIG. 2).

Door support frames 28a and 28b include coupling portion 32a and 32b, guide portions 34a and 34b, and fingers 36a and 36b, respectively. Coupling portions 32a and 32b are attached to the lower portions of door panels 14a and 14b. Guide portions 34a and 34b, which are continuations formed at the bottoms of coupling portions 32a and 32b, are inserted into groove 40 in doorsill 24 to guide door support frames 28a and 28b in groove 40. Fingers 36a and 36b extend horizontally from guide portion 34a and 34b so that they project beyond the right edge and left edge of door panel 14a and 14b (as viewed in FIG. 1), respectively.

Door support frames 28a, 28b are attached to door panels 14a, 14b at coupling portions 32a, 32b. These coupling portions 32a, 32b preferably are long enough so that they can be continuously attached to the lower ends of door panels 14a, 14b. Thus, coupling portions 32a, 32b preferably each have a length corresponding to between about 50% and 100% of the width of their respective door panels 14a, 14b.

Fingers 36a, 36b of door support frames 28a, 28b are installed so that finger 36a of left door panel 14a extends below a portion of right door panel 14b and finger 36b of right door panel 14b extends below a portion of left door panel 14a when door 12 is closed. Thus, if a force causes the bottom of either door panel 14 to move upward when door 12 is closed, finger 36a of left door panel 14a is able to engage the bottom of right door panel 14b, and finger 36b of right door panel 14b is able to engage the bottom of left door panel 14a.

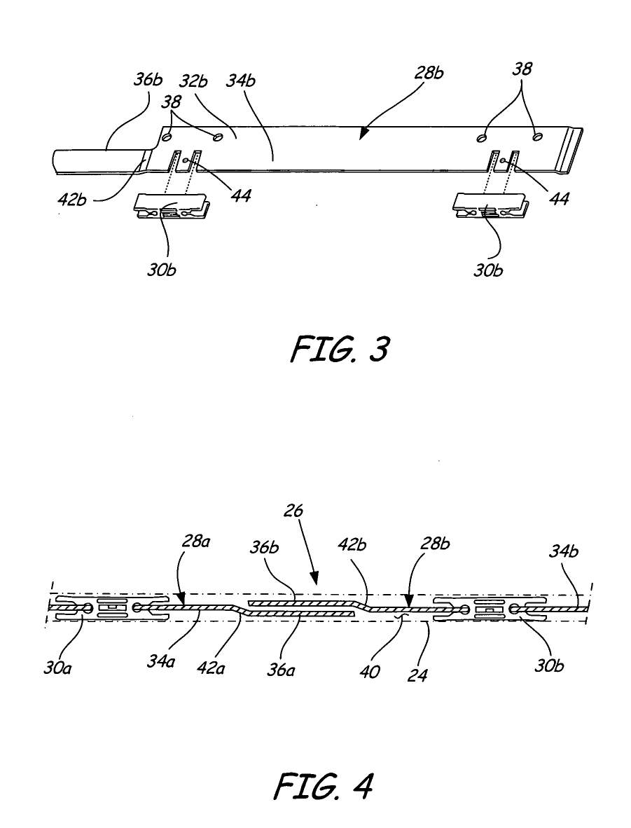

FIG. 3 shows a detailed view of door support frame 28b, which is disconnected from right door panel 14b. Door support frame 28a has a construction that is generally similar to door support frame 28b shown in FIG. 3. The following description of door support frame 28b, therefore, is applicable to door support frame 28a as well.

As shown in FIG. 3, door support frame 28b is preferably formed as a single piece having coupling portion 32b, guide portion 34b, and finger 36b. Coupling portion 32b has holes 38b for connecting door support frame 28b to door panel 14b. As shown, coupling portion 32b is formed integrally with guide portion 34b. When taking into consideration preparation and assembly, the convenience of maintenance and control, and the connection strength, finger 36b is preferably integrally formed with guide portion 34. However, finger 36b can also be connected with guide portion 34b by assembly. Finger 36b is preferably formed with bend 42b so that it is offset either to the front or rear with respect to guide portion 34b.

Door shoes 30a, 30b, which are made of a suitable material such as plastic or rubber material, are attached to guide portions 34a, 34b, respectively. Door shoes 30a, 30b can be easily fixed to or removed from door support frames 28a, 28b by assembly means such as using bolts. Alternatively, as illustrated by FIG. 3, door shoes 30a, 30b can be fixed to door support frames 28a, 28b by tabs 44 in guide portions 34a, 34b that extend from coupling portions 32a, 32b to connect door shoes 30a, 30b to frames 28a, 28b. Tabs 44 may, as shown, be integrally formed with coupling portion 32a and co-planar with guide portion 34a. Door shoes 30a, 30b preferably have a thickness the same as or less than the thickness of door panels 14a, 14b. Door shoes 30a, 30b are not limited to a specific length as long as they can be installed at proper positions. However, to stably guide door panels 14 along groove 40, door shoes 30a, 30b are preferably installed with a separation of half or more than half of the width of door panel 14a or 14b. When inserted into groove 40 of doorsill 24, any vibration or shaking is minimized when door panels 14a, 14b move along groove 40.

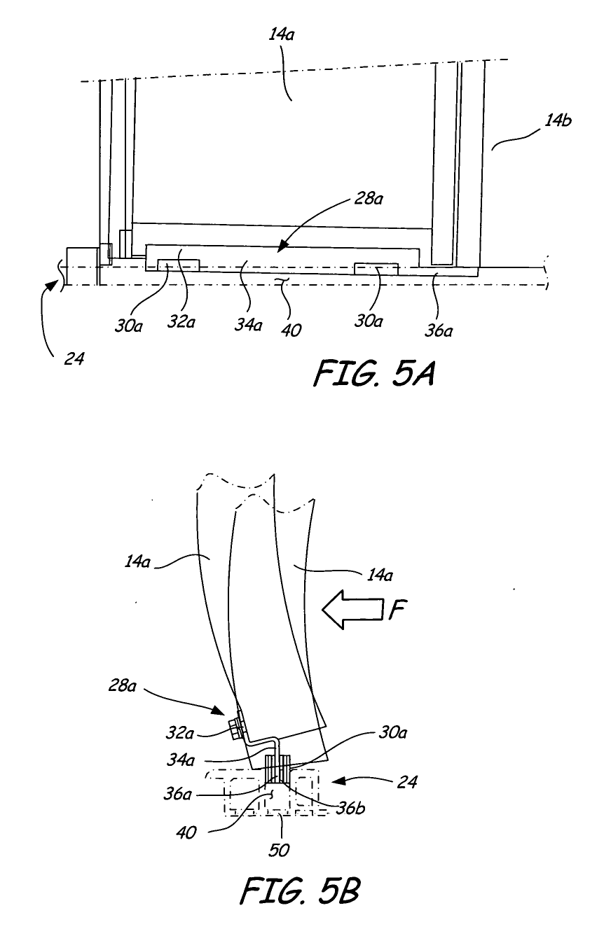

FIG. 4 shows a bottom view of door guide apparatus 26 when door 12 is closed. Finger 36a is preferably formed relatively forward or rearward of the finger 36b, so that the distal portions of fingers 36a, 36b overlap when door 12 is closed. If fingers 36a, 36b are formed in an offset with respect to the guide portions 34a, 34b, especially when door panels 14a, 14b are driven by a sliding opening and closing system, finger 36a is positioned to the front or rear relative to finger 36b. Thus, as shown in FIG. 4, even if guide portions 34a, 34b are positioned on the same horizontal line, when elevator door 12 is closed, fingers 36a and finger 36b overlap each other without interfering with each other. When elevator door 12 is closed, the amount by which the fingers 36a and 36b overlap each other can be as much as substantially the entire length of fingers 36a, 36b. When fingers 36a, 36b are overlapped, if door panel 14a is pushed inwardly (i.e., upwardly in FIG. 4) by a force, finger 36a initially pushes against other finger 36b prior to pushing against doorsill 24. On the other hand, if door panel 14a is pushed outwardly (i.e., downwardly in FIG. 4) by a force, finger 36a initially contacts the doorsill 24 then pushes against the other finger 36b due to a moment-induced rotation of the finger 36a (as shown in FIG. 5B). In both cases, the inward or outward force applied to door panel 14a can be more consistently distributed and transmitted by the multistage connection.

Of course, with respect to door panel 14b, when fingers 36a, 36b are overlapped, if door panel 14b is pushed outwardly (i.e., downwardly in FIG. 4) by a force, finger 36b initially pushes against other finger 36a prior to pushing against doorsill 24. On the other hand, if door panel 14b is pushed inwardly (i.e., upwardly in FIG. 4) by a force, finger 36b initially contacts the doorsill 24 and then pushes against the other finger 36a due to a moment-induced rotation of the finger 36b (as shown in FIG. 5B). In both cases, the inward or outward force applied to door panel 14b can be more consistently distributed and transmitted by the multistage connection.

FIGS. 5A and 5B show how door guide apparatus 26 responds when a lateral force F is applied to door panel 14a. As shown in FIG. 5B, when such a force F is applied to door panel 14a, a shear force and a bending stress are exerted on door support frame 28a, particularly on support portion 32a and guide portion 34a. As a result, the bottom of door panel 14a moves upward when door 12 is closed, thereby causing: (a) finger 36a to engage against the finger 36b on the bottom of right door panel 14b; and (b) guide portion 34a to transmit some of the force from door panel 14a to doorsill 24. Thus, some of the force F is transmitted and distributed to right door panel 14b and the remainder of the force F is absorbed by doorsill 24. Also, because finger 36a engages the bottom of right door panel 14b, the door support frame 28a and door shoes 30 remain in groove 40. Because door support frame 28a integrates support portion 32a and guide portion 34a into a single structure continuously attached over a majority of door panel 14a rather than having an apparatus comprising multiple segments each separately attached to door panel 14a, several benefits are achieved. Door support frame 28a is more rigidly mounted and, when force is applied to door 12, the pressure can be simultaneously absorbed by both guide portion 34a and support portion 32a. Thus, much improved shear strength and bending strength are realized, compared with the conventional structure in which the door coupling parts are installed separately in the form of connecting segments.

As seen in FIG. 5B, doorsill 24 may optionally include foreign matter discharge hole 50, which penetrates vertically into the lower part of groove 40 so that any foreign matter in groove 40 can be discharged downward when door support frames 28a, 28b or door shoes 30a, 30b move. Foreign matter is pushed along groove 40 in the doorsill 24 by door support frames 28a, 28b or door shoes 30a, 30b during opening and closing operations of the door. When the doors are closed, foreign matter discharge hole 50 can extend from the right edge of door shoe 30a installed on the rightmost side of left door panel 14a up to the left side of door shoe 30b installed on the leftmost side of right door panel 14b. On the other hand, foreign matter discharge hole 50 can extend for the intersecting length between finger 36a of left door panel 14a and finger 36b of right door panel 14b. With either arrangement, foreign matter discharge hole 50 can realize the same degree of foreign matter discharge effect without excessively extending foreign matter discharge hole 50. Furthermore, when door 12 is closed and fingers 36a, 36b of door support frames 28a, 28b overlap along groove 40 in doorsill 24, there is little space in which foreign matter can accumulate because no gap is formed between door support frames 28a, 28b or door shoes 30a, 30b.

According to the present invention, when the door 12 is closed, even if a force is applied unequally to one door panel 14a or 14b, the force is always substantially uniformly distributed to both door panels 14a, 14b and a sturdy state of engagement is maintained. Regardless of the unequal application of the force, the force is transmitted and distributed substantially uniformly because finger 36a of door support frame 28a is engaged with finger 36b of the door support frame 28b at the bottom of the opposite door panel 14b. Because both the door guide function and the breakaway inhibition function can be realized using only the door guide apparatus 26 of the instant invention, without the need to provide a separate door injury deterrent apparatus, the installation and repair costs are reduced. Furthermore, because of the foreign matter discharge hole 50, foreign matter does not build up in groove 40 and door 12 can open and close smoothly.

The aforementioned discussion is intended to be merely illustrative of the present invention and should not be construed as limiting the appended claims to any particular embodiment or group of embodiments. For example, as the elevator door system is described generically, it may be used in one or both of elevator car doors and/or to elevator hoistway doors. Thus, while the present invention has been described in particular detail with reference to specific exemplary embodiments thereof, it should also be appreciated that numerous modifications and changes may be made thereto without departing from the broader and intended scope of the invention as set forth in the claims that follow.

The specification and drawings are accordingly to be regarded in an illustrative manner and are not intended to limit the scope of the appended claims. In light of the foregoing disclosure of the present invention, one versed in the art would appreciate that there may be other embodiments and modifications within the scope of the present invention. Accordingly, all modifications attainable by one versed in the art from the present disclosure within the scope of the present invention are to be included as further embodiments of the present invention. The scope of the present invention is to be defined as set forth in the following claims.

1. An elevator door system comprising:
a doorsill;
a first door panel adjacent to the doorsill;
a second door panel adjacent to the doorsill;
a first door support frame attached at a lower end of the first door panel, the first door support frame having a first finger that extends horizontally beyond an edge of the first door panel towards the second door panel;
a second door support frame attached at a lower end of the second door panel, the second door support frame having a second finger that extends horizontally beyond an edge of the second door panel towards the first door panel; and
door shoes connected to the first door support frame and the second door support frame, wherein the door shoes are slidably engaged with a groove in the doorsill to guide the movement of the first door panel and second door panel.

2. The elevator door system of claim 1, wherein the first door support frame and second door support frame are engaged with the groove.

3. The elevator door system of claim 1, wherein the first finger of the first door support frame overlaps at least a portion of the second finger of the second door support frame when the door panels are closed.

4. The elevator door system of claim 1, wherein the first finger of the first door support frame extends below the second door panel when the door panels are closed.

5. The elevator door system of claim 1, wherein, when the door panels are closed, the first finger of the first door support frame is positioned so that the first finger engages the second door panel when an upward force is applied to the first door panel.

6. The elevator door system of claim 1, wherein the first finger is offset from the first door support frame.

7. The elevator door system of claim 1, further comprising:
a hole in the doorsill for allowing removal of foreign matter from the groove in the doorsill.

8. The elevator door system of claim 1, wherein the first door support frame continuously covers more than substantially 50% of a width of the first door panel and the second support frame continuously covers more than substatially 50% of a width of the second door panel.

9. An elevator door system comprising:
an elevator door having a first door panel, a second door panel, and a doorsill;
a first door support frame attached at a lower portion of the first door panel, the first door support frame having a first finger that extends below the second door panel when the elevator door is closed; and
a second door support frame attached at a lower portion of the second door panel, the second door support frame having a second finger that extends below the first door panel when the elevator door is closed.

10. The elevator door system of claim 9, wherein, when a force is applied to the elevator door, the first finger engages the second door panel and the second finger engages the first door panel.

11. The elevator door system of claim 9, further comprising:
a groove in the doorsill; and
door shoes connected to the first door support frame and the second door support frame and engaged with the groove to guide the movement of the first door panel and the second door panel.

12. The elevator door system of claim 11, further comprising:
a hole in the doorsill for allowing removal of foreign matter from the groove.

13. An elevator door guide apparatus comprising:
a door support frame comprising:
a coupling portion having an upper end and a lower end;
a guide portion extending vertically from the lower end of the coupling portion; and
a finger extending from the guide portion in a horizontal direction.

14. The elevator door guide apparatus of claim 13, further comprising:
door shoes attached to the door support frame.

15. The elevator door guide apparatus of claim 14, wherein the door shoes are attached to the guide portion of the door support frame.

16. The elevator door guide apparatus of claim 15, wherein the guide portion has tabs for attaching the door shoes to the guide portion.

17. The elevator door guide apparatus of claim 13, further comprising:
a bend between the finger and the guide portion such that the finger is offset from the guide portion.

18. The elevator door guide apparatus of claim 13, wherein the coupling portion has holes for connecting the door support frame to a door panel.

19. The elevator door guide apparatus of claim 13, wherein the guide portion is formed integrally with the coupling portion.

20. The elevator door guide apparatus of claim 13, wherein the finger is formed integrally with the guide portion.
